(19) United States
(12) Patent Application Publication
(10) Pub. No.: US 2022/0304899 A1
(43) Pub. Date: Sep. 29, 2022

(54) BABY BOTTLE STAND AND TEETHER TOY APPARATUS

(71) Applicant: Dawn Wagner, (US)

(72) Inventor: Dawn Wagner, Massapequa, NY (US)

(21) Appl. No.: 17/215,672

(22) Filed: Mar. 29, 2021

(51) Int. Cl. A61J 17/02; A61J 17/00; A61J 9/06

(52) U.S. Cl. CPC A61J 17/02; A61J 17/1011; A61J 17/109; A61J 9/0661

(57) ABSTRACT

Apparatus to secure a beverage container in an upright position and provide a surface for teething. The apparatus includes a body, a plurality of feet, and a head. The body includes an interior circumference. A wall of the body along the interior circumference defines an aperture through the body. The aperture is configured to receive and secure a base of the beverage container with the beverage container in an upright position. Each foot of the plurality of feet is connected to the body. The head is connected to the body.

### TECHNICAL FIELD

The present disclosure generally relates to baby bottle stands, and more particularly, to baby bottle stands configured with teether functionality.

### BACKGROUND

Unless otherwise indicated herein, the materials described in this section are not prior art to the claims in this application and are not admitted being prior art by inclusion in this section.

Baby bottles may be used when feeding an infant and may be filled with essential liquid nourishment for the infant, such as milk, breast milk, or formula. When feeding an infant, a parent or caregiver may be required to place the baby bottle down to tend to the infant. A liquid filled baby bottle may need to be stood up in an upright position to prevent the liquid inside from dripping or spilling. Milk, breast milk, or formula may stain or ruin a surface of material that it is spilled upon and may leave a sour odor. Most baby bottles may be configured to stand upright on a hard, flat surface such as a table, but may not stand upright when placed upon soft surfaces such as a couch, ottoman, bed, blanket, cushion, pillow, or an arm of a chair.

### SUMMARY

Existing challenges associated with the foregoing, as well as other challenges, are overcome by the presently disclosed baby bottle stand and teether toy apparatus to help users safely and conveniently stand a baby bottle when feeding an infant.

One embodiment of the present disclosure is an apparatus to secure a beverage container in an upright position and providing a surface for teething. The apparatus includes a body, a plurality of feet, and a head. The body includes an interior circumference. A wall of the body along the interior circumference defines an aperture through the body. The aperture is configured to receive and secure a base of the beverage container with the beverage container in an upright position. Each foot of the plurality of feet is connected to the body. The head is connected to the body.

In aspects, the body is a toroid in shape and is fabricated from polyester material, stuffed with polyester fibers, and stitched together with child safe embroidered thread.

In aspects, each foot includes a connector and a teething apparatus, the teething apparatus includes a teething surface, and a crinkle material is encased within the teething apparatus beneath the teething surface.

In aspects, the teething surface includes a tricot fabric.

In aspects, the head includes two ears, and the ears are configured as teething structures.

In aspects, the head includes a jingle bell.

In aspects, the head includes an image of a face.

Another embodiment of the present disclosure includes an apparatus to secure a beverage container in an upright position and provide a surface for teething. The apparatus includes a body, a plurality of feet, and a head. The body is fabricated from polyester material, stuffed with polyester fibers, and stitched together with child safe embroidered thread. The body includes an interior circumference. A wall of the body along the interior circumference defines an aperture through the body. The aperture is configured to receive and secure the base of the beverage container with the beverage container in an upright position. Each foot of the plurality of feet includes a teething apparatus. Each teething apparatus is connected to the body. Each teething apparatus includes a teething surface, and a crinkle material is encased within each teething apparatus beneath the teething surface. The head is connected to the body.

In aspects, the body is a toroid in shape and includes material of different colors or a pattern.

In aspects, the teething surface includes a tricot fabric, and the tricot fabric includes a pattern with stimulating bright colors.

Another embodiment of the present disclosure is a method for securing a beverage container in an upright position. The method includes receiving a base of a beverage container in an aperture of an apparatus. The apparatus includes a body, a plurality of feet, and a head. The body includes an interior circumference. A wall of the body along the interior circumference defines the aperture through the body. The aperture is configured to receive and secure the base of the beverage container with the beverage container in an upright position. Each foot of the plurality of feet is connected to the body. The head is connected to the body. The plurality of feet and the head provide a larger and more stable foundation to the apparatus. The method further includes securing the beverage container within the aperture of the apparatus and placing the apparatus on a surface with the beverage container in an upright position.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a front/top view of a baby bottle stand and teether toy apparatus;

FIG. 2 is a back/bottom view of a baby bottle stand and teether toy apparatus;

FIG. 3 is a side perspective view of a baby bottle stand and teether toy apparatus holding a baby bottle; and

FIG. 4 illustrates a flow diagram for an example method to secure and support a beverage container in an upright position, all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

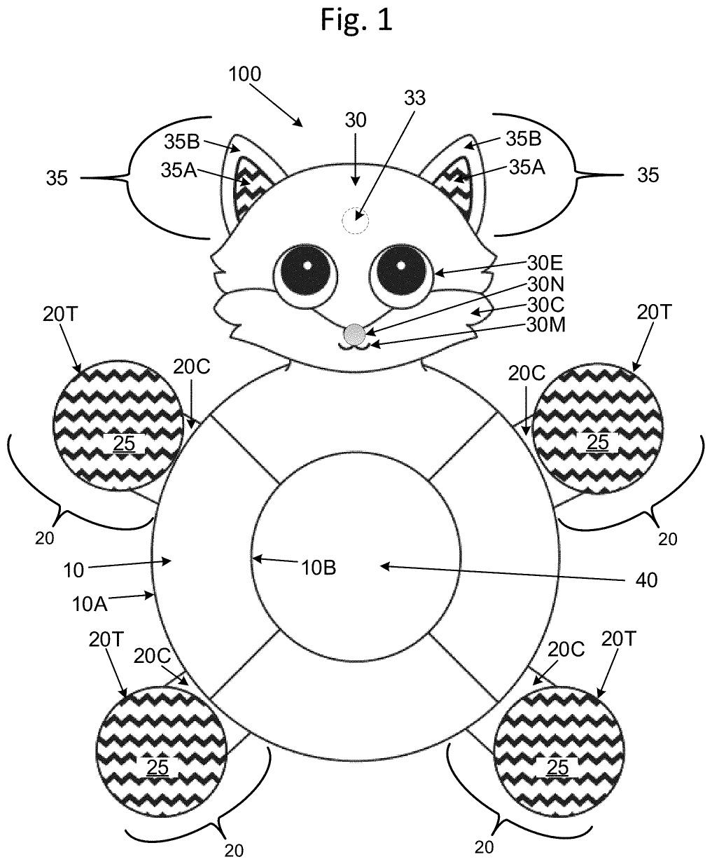

FIG. 1 is a front/top view of a baby bottle stand and teether toy apparatus, arranged in accordance with at least some embodiments described herein. Baby bottle stand and teether toy apparatus 100 may include body 10, a plurality of feet 20, and a head 30. Body 10 may essentially be a toroid in shape, such as a doughnut or ring, and may include a perimeter circumference 10A and an interior circumference 10B. Wall of body 10 along interior circumference 10B may define an aperture 40 through body 10. Aperture 40 may be configured to receive and secure a base of a standard baby bottle, wide-neck baby bottle, sippy cup, or other beverage container with the standard baby bottle, wide-neck baby bottle, sippy cup, or other beverage container in an upright position within aperture 40. Aperture 40 may be essentially circular in shape, although other shapes are contemplated. Although body 10 is described as a toroid in shape, it will be apparent to those skilled in the art that any change may be made to the shape of body 10 without departing from the scope of the disclosure provided body 10 defines aperture 40 through body 10 to receive and secure a base of a standard baby bottle, wide-neck baby bottle, sippy cup, or other beverage container with the standard baby bottle, wide-neck baby bottle, sippy cup, or other beverage container in an upright position within aperture 40. In an example, aperture 40 may have a diameter of 2 inches and body 10 may be toroid in shape with an outer diameter of 4 inches. In another example, aperture 40 may have a diameter of 2.5 inches and body 10 may be a toroid in shape with an outer diameter of 4.5 inches.

Body 10 may be soft, machine washable, and hypoallergenic and may be fabricated from a single material or a combination of materials including, cotton, natural fibers, and synthetic fibers. In one embodiment, body 10 may be fabricated from polyester material and stuffed with polyester fibers. Body 10 may be stitched together with child safe embroidered thread. Body 10 may include material of different colors and may include a pattern or other visual stimulus. Patterns may be within the material or may be created by combining different color materials and may be random, intermittent, repeating, dense, or sparse. In a preferred embodiment, stimulating bright colors may be used.

Each foot 20, of plurality of feet 20, may be connected to perimeter circumference 10A of body 10 and may include a teething apparatus 20T and a connecter 20C. Each connector 20C may connect a respective teething apparatus 20T with perimeter circumference 10A of body 10 and may be fabricated from the same material as body 10. Connectors 20C may be stitched together with child safe embroidered thread. In an embodiment, baby bottle stand and teether toy apparatus 100 may include four feet.

Each teething apparatus 20T may be essentially spheroidal in shape, although other shapes are contemplated. Each teething apparatus 20T may be configured with a teething surface 25 comprising a soft, durable material such as tricot material. A crinkle sound material such as a crinkle material plastic film may be encased within each teething apparatus 20T directly beneath teething surface 25 and may provide a crinkle sound and/or tactile stimulation when teething apparatus 20T is compressed such as when an infant chews or grabs teething apparatus 20T while teething or playing. Each teething apparatus 20T may further be stuffed with a material such as polyester fibers. Material of teething surface 25 of teething apparatus 20T may include different colors and may include a pattern or other visual stimulus. Patterns may be custom, may be within the material, and may be random, intermittent, repeating, dense, or sparse. In an example, pattern may be a custom repeatable pattern with PANTONE colors and may encourage visual tracking for an infant or child. In a preferred embodiment, stimulating bright colors may be used. Each teething apparatus 20T may be stitched together with child safe embroidered thread.

Head 30 may be connected to perimeter circumference 10A of body 10 on a first side and may include two ears 35 projecting out from a second side of head 30, opposite from the first side. Ears 35 may be configured as teething structures and may include a first surface 35A and a second surface 35B on a front/top side of ears 35. Surface 35A may comprising a soft, durable material such as tricot material and surface 35B may include a soft plush material such as polyester. A crinkle sound material, such as a crinkle material plastic film, may be encased within ear 30 directly beneath surface 35A and surface 35B and may provide a crinkle sound and/or tactile stimulation when ear 35 is compressed such as when an infant chews or grabs ear 35 while teething or playing. Ears 35 may be stitched together with child safe embroidered thread. In another embodiment, surface 35A and surface 35B of ears 35 may comprise a soft plush material such as polyester.

Head 30 may be soft, machine washable, and hypoallergenic and may be fabricated from a single material or a combination of materials including, felt, cotton, natural fibers, and synthetic fibers. In one embodiment, head 30 may be constructed from polyester material and stuffed with polyester fibers. Head 30 may include a jingle bell 33 sewn within head 30 to provide audio stimulation. Jingle bell 33 may allow baby bottle stand and teether toy apparatus 100 to act as a rattle toy. Head 30 may be three-dimensional and stitched together with child safe embroidered thread. Front/top side of head 30 may include a three-dimensional image of a face and may include details such as eyes 30E, a nose 30N, cheeks 30C, and a mouth 30M. Face details included on head 30 may be fabricated from felt and may be stitched into head 30 with child safe embroidered thread. Nose 30N may project out from head 30 and may be fabricated from the same material as head 30. In some examples, nose 30 may be a trunk of an elephant or a beak of a bird.

In an embodiment, baby bottle stand and teether toy apparatus 100 may be soft, machine washable, and hypoallergenic.

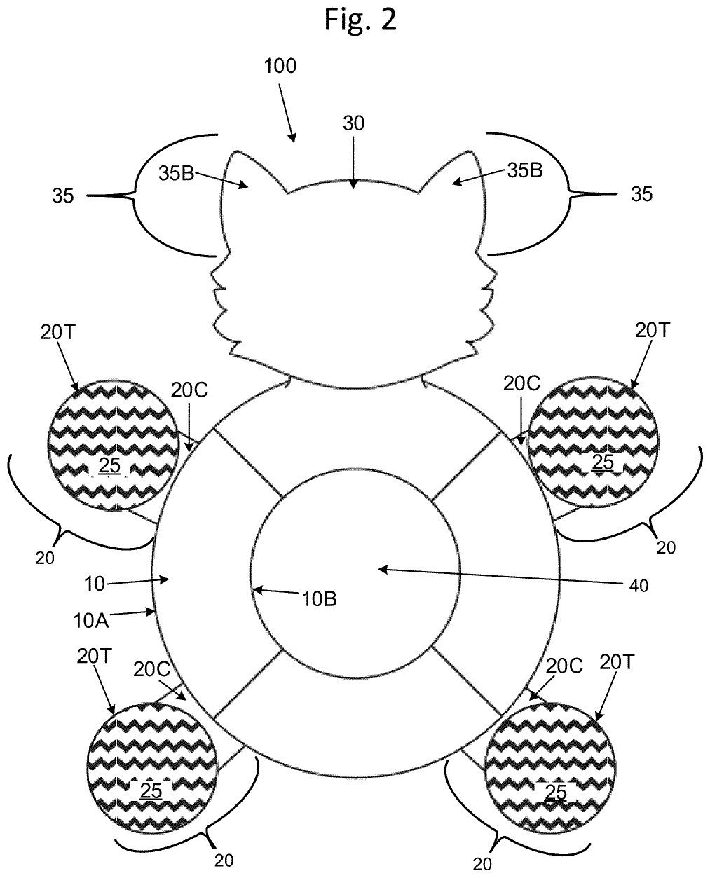

FIG. 2 is a back/bottom view of a baby bottle stand and teether toy apparatus, arranged in accordance with at least some embodiments described herein. Those components in FIG. 2 that are labeled identically to components of FIG. 1 will not be described again for the purposes of brevity.

As previously described, head 30 may be connected to perimeter circumference 10A of body 10. In some embodiments, head 30 may include two ears 35 projecting out from head 30. Back/bottom side of ears 35 may include surface 35B, a soft plush material such as polyester. A crinkle sound material such as a crinkle material plastic film may be encased within ear 30 directly beneath surface 35B and may provide a crinkle sound when ear 35 is compressed such as when an infant chews or grabs ear 35 while teething or playing.

Back/bottom side of head 30 may be essentially flat in profile and may lay flat when baby bottle stand and teether toy apparatus 100 is placed on a surface. Back/bottom of head 30 and legs 20 may increase a surface area of baby bottle stand and teether toy apparatus 100 that is in contact with a surface baby bottle stand and teether toy apparatus 100 is placed upon. Back/bottom of head 30 and legs 20 may add stability to baby bottle stand and teether toy apparatus 100 when baby bottle stand and teether toy apparatus 100 is placed on a surface.

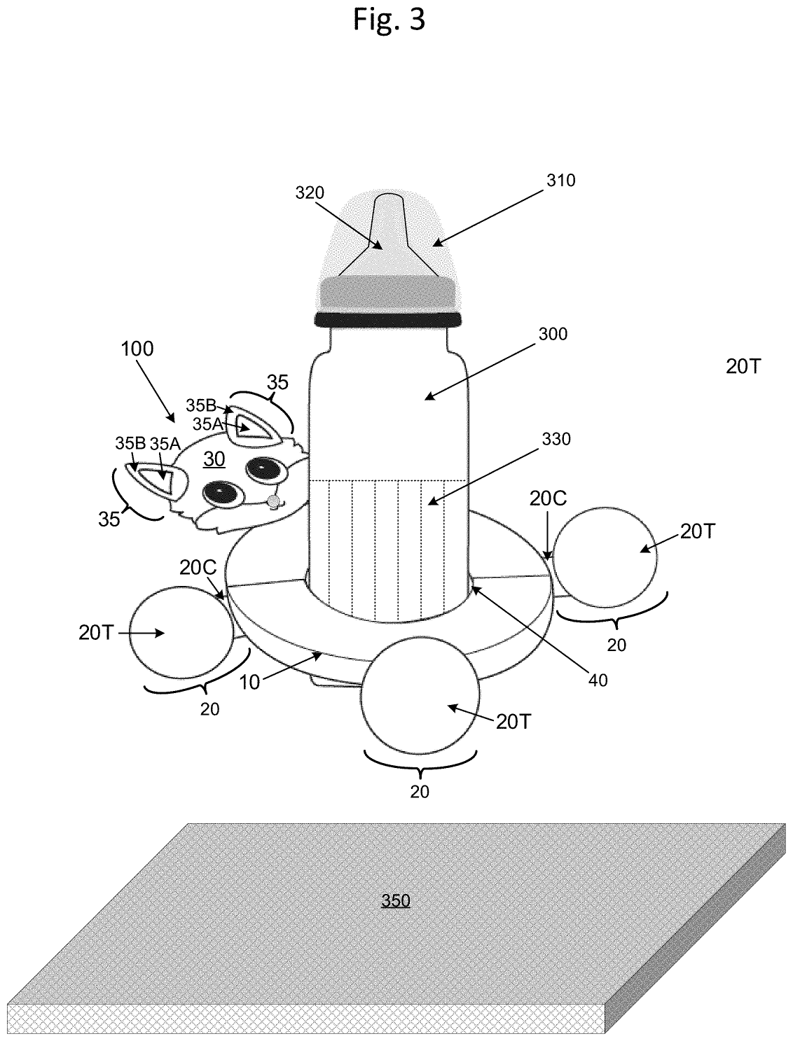

FIG. 3 is a side perspective view of a baby bottle stand and teether apparatus holding a baby bottle, arranged in accordance with at least some embodiments described herein. Those components in FIG. 3 that are labeled identically to components of FIGS. 1-2 will not be described again for the purposes of brevity.

As previously stated, aperture 40, defined by inner walls of body 10, may be configured to receive a base of standard baby bottle, wide-neck baby bottle, sippy cup, or other beverage container 300, within aperture 40. Standard baby bottle, wide-neck baby bottle, sippy cup, or other beverage container 300 may contain a liquid 330. Liquid 330 may be milk, breast milk, formula, juice, water, or any other beverage. In an example, beverage container 30 may be a baby bottle and may include a cover 310 and a nipple 320. Neither cover 310 nor nipple 320 may be liquid tight, and liquid 300 may spill from beverage container 300 if beverage container 300 is not kept in an upright position. Aperture 40 of baby bottle stand and teether toy apparatus 100 may be configured to secure and support beverage container 300 in an upright position when a base of beverage container 300 is placed within aperture 40, and baby bottle stand and teether toy apparatus 100, secured to beverage container 300, is placed on a surface 350.

Surface 350 may be a soft surface such as a couch, ottoman, bed, blanket, cushion, pillow, or an arm of a chair. Body 10 of baby bottle stand and teether toy apparatus 100 may be secured to a circumference of beverage container 300 by friction when a base of beverage container 300 is placed within aperture 40 of bottle stand and teether toy apparatus 100. Head 30 and plurality of feet 20 may provide a larger and more stable supporting foundation to beverage container 300 when beverage container 300 is secured within aperture 40 of baby bottle stand and teether toy apparatus 100 in an upright position and may prevent beverage container 300 from falling over and spilling liquid 330. Head 30 and plurality of feet 20 may further provide a counterbalance for beverage container 300 when beverage container 300 is secured within aperture 40 of baby bottle stand and teether toy apparatus 100 and keep beverage container 300 in an upright position to prevent beverage container 300 from spilling liquid 330.

A device in accordance with the present disclosure may provide a user with a baby bottle stand and teether toy apparatus that can support a baby bottle in an upright position on a soft surface such as a couch, ottoman, bed, blanket, cushion, pillow, or an arm of a chair. A device in accordance with the present disclosure may prevent a baby bottle from spilling liquid when the baby bottle is placed on a soft surface while a user is feeding a baby. A device in accordance with the present disclosure may provide a baby with an interactive teething toy that is plush, colorful, and makes noise. A device in accordance with the present disclosure may provide a baby with an interactive teething toy that encourages visual tracking. A device in accordance with the present disclosure may provide a baby with an interactive teething toy that provides visual and tactile stimulation.

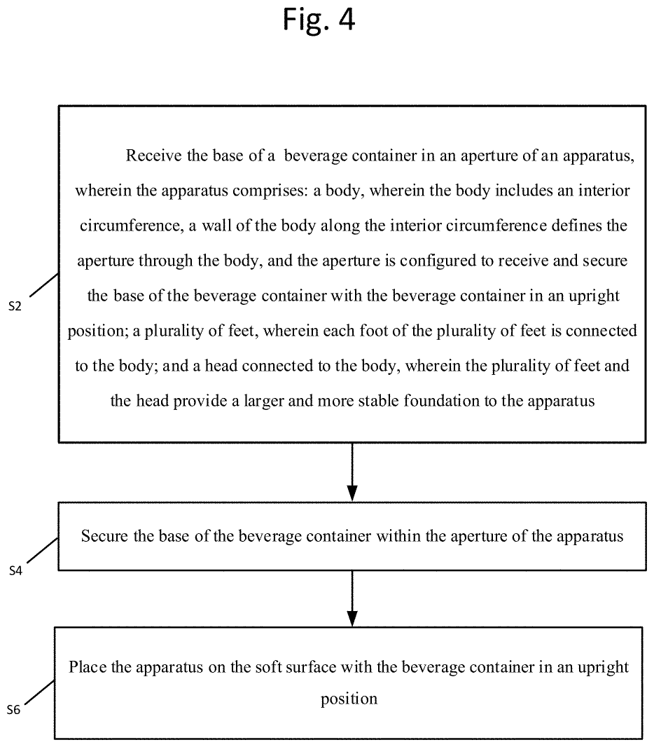

FIG. 4 illustrates a flow diagram for an example method to secure and support a baby bottle in an upright position, arranged in accordance with at least some aspects presented herein. An example process may include one or more operations, actions, or functions as illustrated by one or more of blocks S2, S4, and/or S6. Although illustrated as discrete blocks, various blocks may be divided into additional blocks, combined into fewer blocks, or eliminated, depending on the desired implementation.

Processing may begin at block S2, “Receive the base of a beverage container in an aperture of an apparatus, wherein the apparatus comprises: a body, wherein the body includes an interior circumference, a wall of the body along the interior circumference defines the aperture through the body, and the aperture is configured to receive and secure the base of the beverage container with the beverage container in an upright position; a plurality of feet, wherein each foot of the plurality of feet is connected to the body; and a head connected to the body, wherein the plurality of feet and the head provide a larger and more stable foundation to the apparatus”. At block S2, an apparatus may receive a base of a beverage container. The beverage container may be a standard baby bottle, a wide-neck baby bottle, a sippy cup, or any other beverage container. The apparatus may include a body, a plurality of feet, and a head. The body may include an interior circumference. A wall of the body along the interior circumference may define the aperture through the body. The aperture may be configured to receive and secure the base of the beverage container with the beverage container in an upright position. Each foot of the plurality of feet may be connected to the body. The head may be connected to the body. The plurality of feet and the head may provide a larger and more stable base to the apparatus.

Processing may continue from block S2 to block S4, “Secure the base of the beverage container within the aperture of the apparatus”. At block S4, the beverage container may be secured within the aperture of the apparatus. The aperture of the apparatus may be secured to a circumference of the beverage container by friction when the base of the beverage container is secured within the aperture.

Processing may continue from block S4 to block S6, “Place the apparatus on the soft surface with the beverage container in an upright position”. At block S6, the apparatus may be placed on the soft surface with the beverage container in an upright position. The beverage container may be secured in the upright position by the apparatus and the larger and more stable foundation provided by the apparatus to the beverage container may prevent the beverage container from falling over and spilling liquid contained by the beverage container.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. An apparatus to secure a beverage container in an upright position and provide a surface for teething, the apparatus comprising:
a body, wherein the body includes an interior circumference, a wall of the body along the interior circumference defines an aperture through the body, and the aperture is configured to receive and secure a base of the beverage container with the beverage container in an upright position;
a plurality of feet, wherein each foot of the plurality of feet is connected to the body; and
a head connected to the body.

2. The apparatus of claim 1, wherein the body is a toroid in shape and is fabricated from a single material or a combination of materials including, cotton, natural fibers, and synthetic fibers.

3. The apparatus of claim 1, wherein the body is fabricated from polyester material, stuffed with polyester fibers, and stitched together with child safe embroidered thread.

4. The apparatus of claim 1, wherein the body includes material of different colors or a pattern.

5. The apparatus of claim 1, wherein each foot includes a connector and a teething apparatus, the teething apparatus includes a teething surface, and a crinkle material is encased within the teething apparatus beneath the teething surface.

6. The apparatus of claim 5, wherein the teething surface includes a tricot fabric.

7. The apparatus of claim 6, wherein the tricot fabric includes a pattern with stimulating bright colors.

8. The apparatus of claim 1, wherein the head includes two ears, and the ears are configured as teething structures.

9. The apparatus of claim 8, wherein each ear includes a first surface and a second surface, and a crinkle material is encased within each ear beneath the first surface and the second surface.

10. The apparatus of claim 1, wherein the head includes a jingle bell.

11. The apparatus of claim 1, wherein the head includes an image of a face.

12. An apparatus to secure a beverage container in an upright position and provide a surface for teething, the apparatus comprising:
a body, wherein the body is fabricated from polyester material, stuffed with polyester fibers, and stitched together with child safe embroidered thread, the body includes an interior circumference, a wall of the body along the interior circumference defines an aperture through the body, and the aperture is configured to receive and secure the base of the beverage container with the beverage container in an upright position;
a plurality of feet, wherein each foot of the plurality of feet includes a teething apparatus, each teething apparatus is connected to the body and includes a teething surface, and a crinkle material is encased within each teething apparatus beneath the teething surface; and
a head connected to the body.

13. The apparatus of claim 12, wherein the body is a toroid in shape and includes material of different colors or a pattern.

14. The apparatus of claim 12, wherein the teething surface includes a tricot fabric.

15. The apparatus of claim 14, wherein the tricot fabric includes a pattern with stimulating bright colors.

16. The apparatus of claim 12, wherein the head includes two ears, and the ears are configured as teething structures.

17. The apparatus of claim 12, wherein the head includes a jingle bell.

18. The apparatus of claim 12, wherein the head includes an image of a face.

19. The apparatus of claim 18, wherein the image of the face includes a nose and the nose projects out from the head.

20. A method for securing a beverage container in an upright position, the method comprising:
receiving the base of a beverage container in an aperture of an apparatus, wherein the apparatus comprises:
a body, wherein the body includes an interior circumference, a wall of the body along the interior circumference defines the aperture through the body, and the aperture is configured to receive and secure the base of the beverage container with the beverage container in an upright position;
a plurality of feet, wherein each foot of the plurality of feet is connected to the body; and
a head connected to the body, wherein the plurality of feet and the head provide a larger and more stable foundation to the apparatus;
securing the base of the beverage container within the aperture of the apparatus; and
placing the apparatus on a surface with the beverage container in an upright position.
